(19) United States
(12) Patent Application Publication
(10) Pub. No.: US 2003/0147024 A1
(43) Pub. Date: Aug. 7, 2003

(54) Optical color-change film

(76) Inventor: Chih-Yuan Wang, Taichung Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/061,229

(22) Filed: Feb. 4, 2002

(51) Int. Cl. G02F 1/1335

(52) U.S. Cl. 349/61

(57) ABSTRACT

An optical color-change film utilized to a liquid crystal display is disclosed. The liquid crystal display has a liquid crystal module and a light guide module which has a light guide element. An optical color-change film is installed between the light output surface of the light guide element and the liquid crystal module. The optical color-change film has a thin film transparent substrate. A color-change layer is installed at a bottom of the substrate; a color-change film is a transparent film mixed with pigments. Besides, the substrate is installed with a light enhancing layer; the light enhancing layer is formed by a plurality of optical particles. A plurality of protrusions is installed on the surface of the optical color-change film.

### BACKGROUND OF THE INVENTION

1.Field of the Invention

The present invention relates to an optical color-change film, and particularly to an optical color-change film having the function of color-change and may present desired backlight color with the color of the light source. The present invention has the light enhancing effect.

2. Description of Related Art

Referring to FIG. 8, a light guide module 90 used in a liquid crystal display is illustrated. The light guide module has light source of light emitting diodes or cool cathode fluorescent tubes, which is used in a light guide of backlight. Light from point light source or line light source passes through the light guide surface 921 of a light guide element 92 to the light output surface 922 to the liquid crystal module 93. Then the light passes through the liquid crystal module 93 to emit out. Thereby, the liquid crystal display may display a frame. Therefore, the color of the backlight of the liquid crystal display is determined by the light source 91. If it is desired to have a blue light, a blue light source 91 is necessary. If it is desired to have an orange light, an orange light source 91 is necessary. Therefore, various light sources 91 are necessary for presenting various lights. However, to achieve this object, the color-change function is necessary since the colors of lights from the light sources are finite.

For a liquid crystal display having a white backlight, many light sources of different colors are necessary, such as blue, orange, green, etc. As a result the cost is high.

In general, color-change film 94 mixed pigments is used in color-change. However, the pigment will resist or absorbing light. Since light from the light source 91 is hindered, the hue of the backlight is reduced. Consequently, the liquid crystal display becomes dark.

### SUMMARY OF THE INVENTION

Accordingly, the primary object of the present invention is to provide an optical color-change film utilized to a liquid crystal display. The liquid crystal display has a liquid crystal module and a light guide module which has a light guide element. An optical color-change film is installed between the light output surface of the light guide element and the liquid crystal module. The optical color-change film has a thin film transparent substrate. A color-change layer is installed at a bottom of the substrate; a color-change film is a transparent film mixed with pigments hue diagram; besides, the substrate is installed with a light enhancing layer; the light enhancing layer is formed by a plurality of optical particles; a plurality of protrusions are installed on the surface of the optical color-change film.

The various objects and advantages of the present invention will be more readily understood from the following detailed description when read in conjunction with the appended drawing.

### BRIEF DESCRIPTION OF THE DRAWINGS

FIG. 1 is a schematic perspective view of the present invention.

FIG. 2 is a structural cross section view of the first embodiment of the present invention.

FIG. 3 is a schematic view showing the light of the light source of the present invention is mixed with light from an external light source in a liquid crystal display.

FIG. 4 is a schematic view showing the light of the light source of the present invention is focused and scattered with light from an external light source in a liquid crystal display.

FIG. 5 is a structural schematic view of the second embodiment of the present invention.

FIG. 6 is a structural schematic view of the third embodiment of the present invention.

FIG. 7 is a CIE chromaticity diagram.

FIG. 8 is a schematic view showing the light guide module in a prior art is combined with a color-change film.

### DETAILED DESCRIPTION OF THE PREFERRED EMBODIMENTS

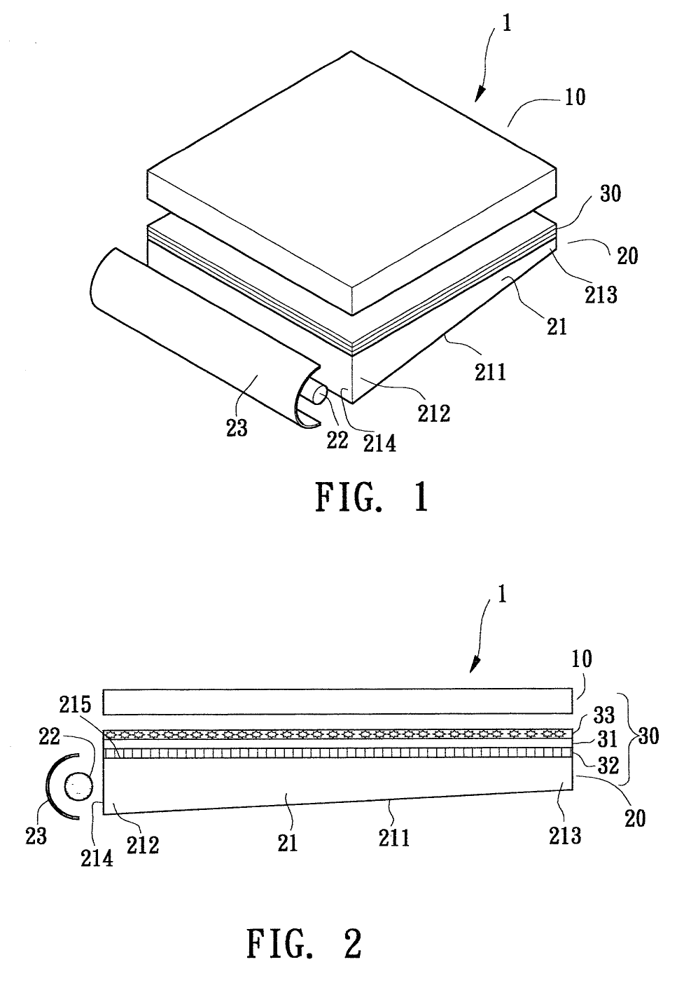

Referring to FIG. 1, the present invention uses the powder coating, or film coating or optical guiding technology.

The optical color-change film 30 of the present invention is used to a liquid crystal display 1. The liquid crystal display 1 has a liquid crystal module 10. The bottom of the liquid crystal module 10 is installed with a light guide module 20. The light guide module 20 has a light guide element 21 made of transparent substrate and having a plate-like shape. The top of the light guide element 21 has a light output surface 215. The bottom of the light guide element 21 has a tilt light guide surface 211. The light guide element 21 is formed with a thick end 212 and a thin end 213 based on the slope of the light guide surface 211. The light guide element 21 has a light inlet surface 214 at the lateral side of the thick end 212. The light inlet surface 214 of the light guide element 21 has a light source 22 at the side away from the thin side 231. The light source 22 has a cambered reflecting plate 23 at the side away from the light guide element 21. The optical color-change film 30 is installed between the light output surface 215 of the light guide element 21 and the liquid crystal module 10. The optical color-change film 30 has a thin film transparent substrate 31. A color-change layer 32 is installed at a bottom of the substrate 31. The color-change layer 32 is a transparent film mixed with pigments (referring to the CIE chromaticity diagram, to cause a liquid crystal display has a purple color, a red light source 22 must be mixed with a blue color-change layer 32). Besides, the substrate 31 is installed with a light-enhancing layer 33. The light-enhancing layer 33 is formed by a plurality of optical particles 331. The optical particles 331 are metal oxide (such as silicon dioxide, glass particles, titanium dioxide, etc.), or inorganic hydroxide (such as Al₂(OH)₃, etc.), or inorganic salt (such as sodium chloride, potassium chloride, etc., organ high molecular materials. A plurality of protrusions 332 is installed on the surface of the optical color-change film 30.

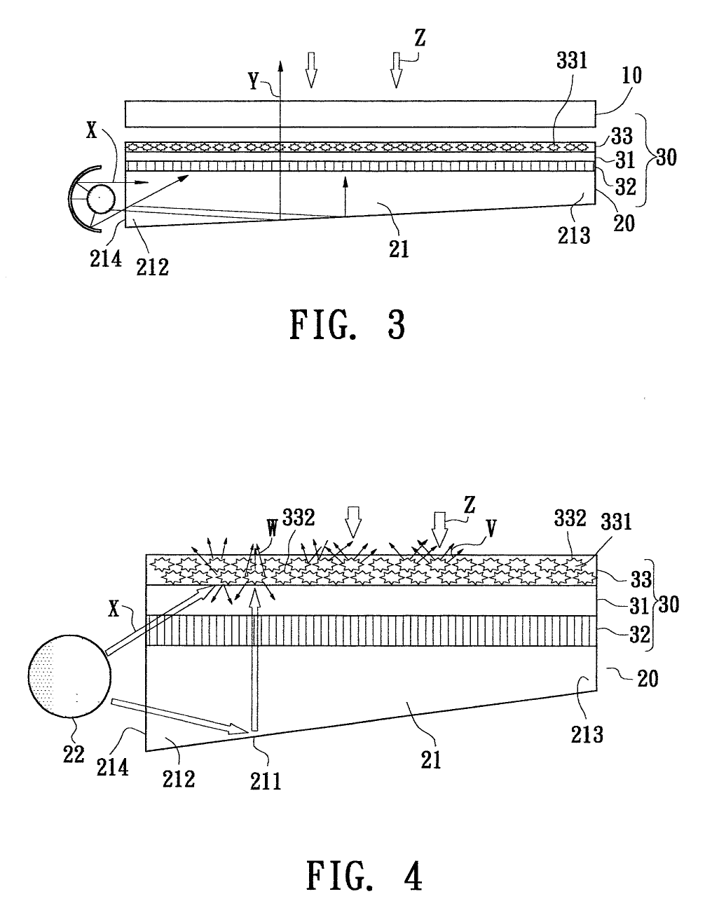

Referring to FIG. 2, the optical color-change film 30 of the present invention is installed on the light guide element 21 of the screen of a handset, screen of a PDA, etc. (not shown). In the process, light X from the light source 22 (in this embodiment, a blue LED light source is used) may incident to or reflected through a reflecting plate 23 to the light inlet surface 214 of the light guide element 21. Thereby, light may incident or reflect to the light output surface 215 and then passes through the optical color-change film 30 (in this example, it has red color). Light becomes changed color Y (purple light after change color, referring to FIG. 3). The light Y may pass through the substrate 31 of the optical color-change film 30 to the light-enhancing layer 33 of the optical color-change film 30. The light Y passes through the plurality of optical particles 331 of the light enhancing layer 33 and then are focuses like passing through a convex lens. Therefore, enhancing light W (referring to FIG. 4) on the liquid crystal module 10 is formed. The enhancing light W passing through the liquid crystal module 10 causes that the liquid crystal display 1 displays a color-changed and enhanced backlight. When the light Y passes through the light enhancing layer 33, the protrusions 332 below the plurality of optical particles 331 will scatter the light Y to form scattering light source 22 so as to destroy full reflecting light and increase the visible luminance of the backlight.

Besides, light Z from the outer light source 22 (sun light or lamp light) of the liquid crystal display 1 passes through the liquid crystal module 10 to the light enhancing layer 33 of the optical color-change film 30. The light Z passes through the protrusions 332 on the surface of the optical particles 331 to be scattered so as to from scattering light to be reflected to the liquid crystal module 10 (referring to FIG. 4). Therefore, the hue of the liquid crystal module 10 is enhanced.

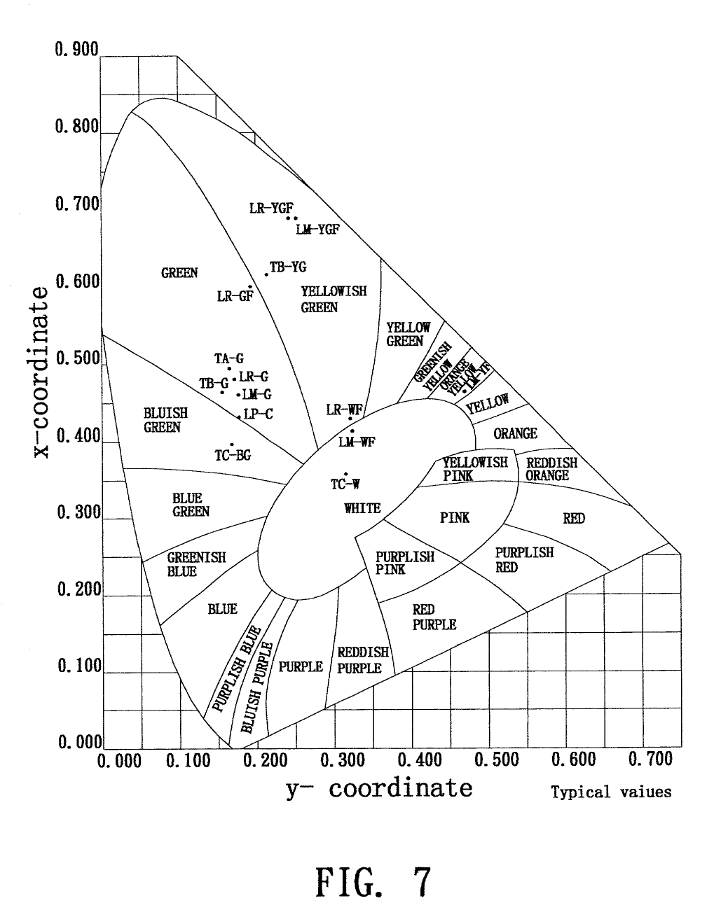

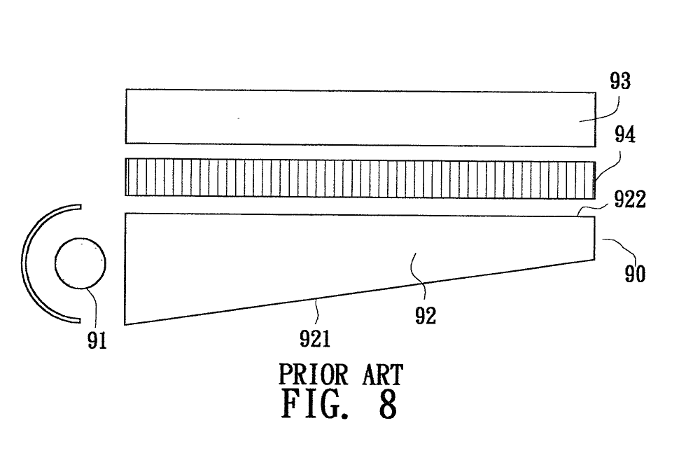

Moreover, the optical color-change film 30 of the present invention may be matched with the color of the light source 22 to have the effect of color change and light enhancing. If the blue light source 22 is used with an orange color-change layer 32, then while backlight presents (referring to FIG. 7). Thus, the light enhancing effect is achieved.

In summary, the optical color-change film 30 of the present invention not only changes the color of the light from the light source 22 by a color-change layer 32, but also backlight of various colors can be presented. Moreover, the light is focused, scattered and reflected and enhanced by the light of the optical particles 331 of the light enhancing layer 33, and thus the illuminance and uniformity of the liquid crystal display 1 is enhanced so that the color of backlight of the liquid crystal display I can be changed.

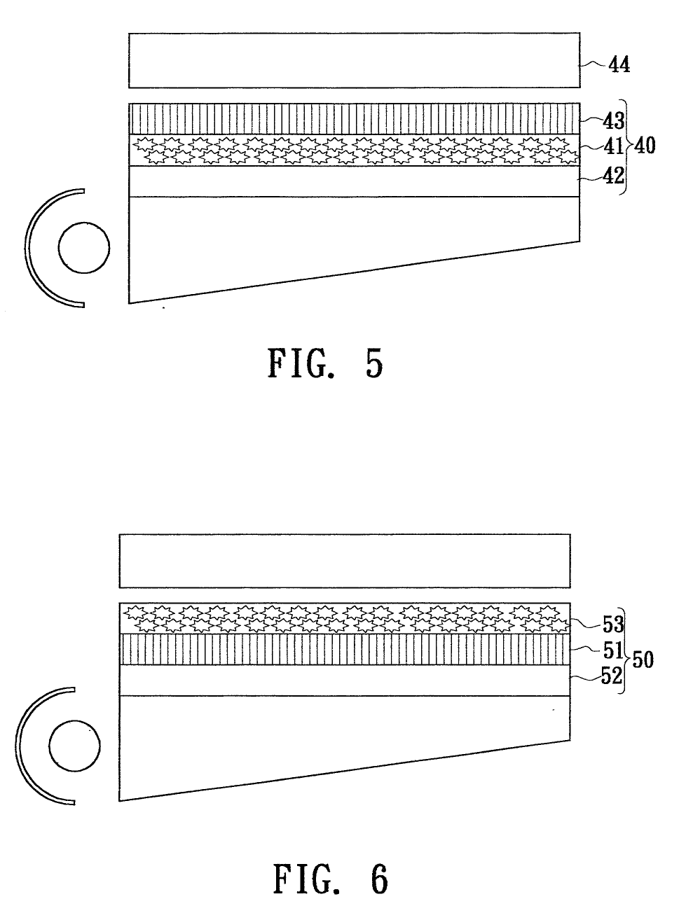

Referring to FIG. 5, a second embodiment of the present invention is illustrated. A light enhancing layer 41 of the optical color-change film 40 is placed between the substrate 42 and the color-change film 42. The color-change film 43 may mix light of different colors and then converts to light of a predetermined color. Since the light enhancing layer 41 of the substrate 42 may increase the hue of the backlight of the liquid crystal module 44, the illuminance is increased greatly. Furthermore, the display element has the effect of light enhancing.

Referring to FIG. 6, the third embodiment of the present invention is illustrated. The color-change film 51 of the optical color-change film 50 is installed between the substrate 52 and the light enhancing layer 53. Thereby, the color-change film 51 will mix the light to a light with a predetermined color. Since the light enhancing layer 53 may increase the hue of the backlight of the liquid crystal module 44, the illuminance is increased greatly. Furthermore, the display element has the effect of light enhancing.

The present invention has the function of color-change and may present desired backlight color with the color of the light source. The present invention has the light enhancing effect. Thus, it can be used in handsets, PDAs, and other electronic devices.

In summary, the optical color-change film of the present invention has the following advantages:

1. Light enhancement: since the light enhancing layer is installed on the substrate, and the light enhancing layer has a plurality of optical particles so that the light enhancing layer may increase the illuminance and hue of the backlight on a liquid crystal display. Thereby, the illuminance of the liquid crystal display is increased.

2. Color-changed function: the color-change film on the optical color-change film is mixed or combined with pigments. Light can be converted into light of other color so as to increase the display light.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. An optical color-change film utilized in a liquid crystal display, wherein the liquid crystal display has a liquid crystal module; a bottom of the liquid crystal module is installed with a light guide module; the light guide module has a light guide element made of transparent substrate and having a plate-like shape; a top of the light guide element has a light output surface; one side of the light guide element has a light source at a side away from the thin side; a light source has a cambered reflecting plate at the side away from the light guide element; the optical color-change film is installed between the light output surface of the light guide element and the liquid crystal module; the optical color-change film has a thin film transparent substrate; a color-change layer is installed at a bottom of the substrate; a color-change layer is a transparent film mixed with pigments; besides, the substrate is installed with a light enhancing layer; the light enhancing layer is formed by a plurality of optical particles; and a plurality of protrusions are installed on the surface of the optical color-change film.

2. The optical color-change film as claim in claim 1, wherein the light enhancing layer of the optical color-change film is connected the substrate and the color-change film.

3. The optical color-change film as claim in claim 1, wherein the color-change layer of color-change film is located between the substrate and the light enhancing layer.

4. The optical color-change film as claim in claim 1, wherein the color-change layer is installed at a bottom of the substrate, and the light enhancing layer is installed at a top of the substrate.

5. The optical color-change film as claim in claim 1, wherein a bottom of the light guide element has a tilt light guide surface; the light guide element is formed with a thick end and a thin end based on a slope of the light guide surface; the light guide element has a light inlet surface at a lateral side of the thick end; a light inlet surface of the light guide element has a light source at a side away from the thin side; the light source has a cambered reflecting plate at the side away from the light guide element.
